(19) United States
(12) Patent Application Publication
(10) Pub. No.: US 2013/0346217 A1
(43) Pub. Date: Dec. 26, 2013

(54) MOBILE DEVICE LOCATION ANALYTICS FOR USE IN CONTENT SELECTION

(71) Applicants: Santosh Pandey, Santa Clara, CA (US); Jagdish Girimaji, Pleasanton, CA (US)

(72) Inventors: Santosh Pandey, Santa Clara, CA (US); Jagdish Girimaji, Pleasanton, CA (US)

(73) Assignee: CISCO TECHNOLOGY, INC., San Jose, CA (US)

(21) Appl. No.: 13/530,821

(22) Filed: Jun. 22, 2012

(51) Int. Cl. G06Q 30/02; H04W 24/00; H04W 4/02; G09F 19/00

(52) U.S. Cl. 705/14.68; 455/456.1; 455/456.5

(57) ABSTRACT

In one embodiment, a method includes receiving location data for a plurality of mobile devices located in an area comprising a display screen, processing at a network device, the location data to generate location analytics for the area, the location analytics comprising dwell time for users of the mobile devices, and transmitting the location analytics to a content source operable to select content for display on the display screen based on the location analytics. An apparatus and logic are also disclosed herein.

### TECHNICAL FIELD

The present disclosure relates generally to communication networks, and more particularly, to location analytics for wireless networks.

### BACKGROUND

Many public areas such as shopping malts display content (e.g., advertisements) on display screens. Each advertisement may vary in duration (e.g., 15, 30, 60 seconds). If the length of time that it takes for the full advertisement to be displayed is greater than the general dwell time of people in the vicinity of the display screen, the intent of the advertisement may be missed by the majority of the people. Therefore, only advertisements that have a duration less than the general dwell time of shoppers in the area should be run. However, dwell time is dynamic and changes over time based on many different factors. For example, a sale in a particular store may increase dwell time in the vicinity of the store, or dwell time may increase in a food court during lunch or dinner time.

### BRIEF DESCRIPTION OF THE FIGURES

FIG. 1 illustrates an example of a network in which embodiments described herein may be implemented.

FIG. 2 depicts an example of a network device useful implementing embodiments described herein.

FIG. 3 is a flowchart illustrating an overview of a process for generating location analytics, in accordance with one embodiment.

FIG. 4 is a flowchart illustrating an overview of a process for content delivery based on location analytics, in accordance with one embodiment.

FIG. 5A is a table showing an example of location analytics.

FIG. 5B is a table showing an example of content data for use in combination with the location analytics to select content for delivery.

FIG. 6 illustrates a mobility pattern of a mobile device without filtering.

FIG. 7 illustrates die mobility pattern of FIG. 6 with filtering, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving location data for a plurality of mobile devices located in an area comprising a display screen, processing at a network device, the location data to generate location analytics for the area, the location analytics comprising dwell time for users of the mobile devices, and transmitting the location analytics to a content source operable to select content for display on the display screen based on the location analytics.

In another embodiment, an apparatus generally comprises a processor for receiving location data for a plurality of mobile devices located in an area comprising a display screen, processing the location data to generate location analytics for the area, the location analytics comprising dwell time for users of the mobile devices, and transmitting the location analytics to a content source operable to select content for display on the display screen based on the location analytics. The apparatus further comprises memory for storing the location analytics.

### EXAMPLE EMBODIMENTS

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Content may be displayed in various locations to provide, for example, information on products or services, sales or other promotions, or other information. Locations include, for example, shopping centers, malls, stores, airports, museums, or any other location in which display, screens may be used to display content to multiple users. Conventional systems use either manually updated or preconfigured content for display and do not take into account dynamic or changing dwell time of users.

The embodiments described herein allow for content selection based on mobile device location analytics, including for example, dwell time of users, number of users, and location and mobility behavior of users. The embodiments provide optimization for timing and duration of content delivery based on actual traffic flow, thereby allowing for more accurate placement of value on advertisements and other content. This makes the network relevant to users without their explicit participation and provides content of appropriate length based on real time location analytics. The embodiments may be used, for example, to enable real time revenue models to price advertisement differently based on the current number of users and their dwell time in the vicinity of the advertisement display.

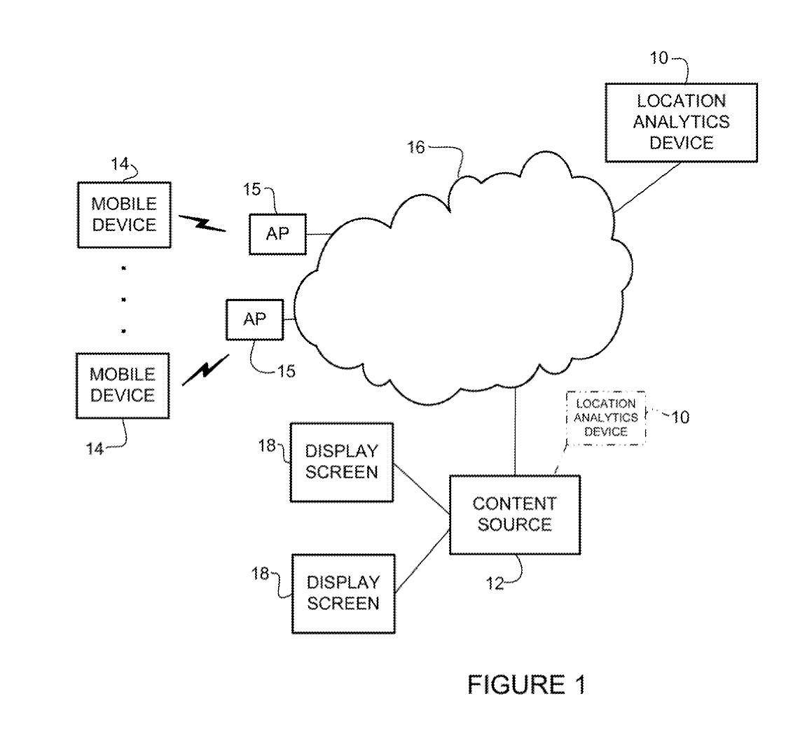

Referring now to the drawings, and first to FIG. 1, an example of a network in which embodiments described herein may be implemented is shown. For simplification, only a small number of network devices are shown. The network includes a location analytics device 10, content source 12, and plurality of mobile devices 14 in communication over a network 16. The network 16 may include one or more networks (e.g., local area network, metropolitan area network, wide area network, wireless local area network, enterprise network, Internet, intranet, radio access network, public switched network, or any other network or combination of networks). The network 16 may include any number or type of intermediate nodes (e.g., routers, switches, gateways, or other network devices), which facilitate passage of data between the network devices. In the example shown in FIG. 1, the location analytics device 10 is in communication with the content source 12 over network 16. The location analytics device 10 may also be integrated with the content source 12 (as shown in phantom in FIG. 1). The content source 12 is operable to automatically select content for display on one or more, display screens 18 based on location analytics received from the location analytics device 10.

The mobile device 14 (also referred to as a wireless device, user device, client device/client, endpoint) may be any suitable equipment that supports wireless communication, including for example, a cellular phone, personal digital assistant, portable computing device, tablet, multimedia device, and the like. The mobile devices 14 communicate with the network 16 via access points 15 using a wireless transmission protocol (e.g., IEEE 802.11/WiFi). The access points 15 may also be in communication with one or more wireless controllers (not shown), which may be configured for communication with the location analytics device 10.

The location analytics device 10 may be, for example, a services engine, such as a Mobility Services Engine, available from Cisco Systems, Inc. of San Jose, Calif., or any other network engine, appliance, device, application, module, or component. The location analytics device 10 may comprise a location services server or receive location data from another network device. The location analytics device 10 may include, for example, a location appliance that operates in conjunction with the access points 15 and a wireless control system. A location appliance, such as Cisco Wireless Location Appliance, may be used to track the physical location of wireless devices 14 to within a few meters. The location of the wireless devices 14 may be based on one or more access points 15.

The location analytics device 10 is associated with an area in which the mobile devices 14 are being monitored in real time. In one embodiment, the location analytics device 10 is configured to identify and track the location of a plurality of mobile devices 14 in a specified area and also track the time spent in the area. The location analytics device 10 may monitor more than one area (e.g.; each area associated with a different display screen 18) or more than one location analytics device 10 may be used to monitor different areas. The area may be defined, for example, by coordinates (e.g., xy coordinates) or relative distance from the display screen 18 or another fixed point. The position of the mobile device 14 may be identified using coordinates within a predefined space (area) or relative position to a specified object. As described below, mobile device location data may be filtered to better identify the actual location and movement of the mobile devices 14. Location analytics are then derived from the filtered location data. The location analytics device 10 transmits the location analytics to content source 12 for use in automated content selection and delivery to one or more display screens 18.

The content source 12 may be, for example, a server that stores the data locally or obtains the data from another server or media source via another network, satellite, cable, or any other communication device. The content source 12 may be part of a content delivery network operable to acquire and transmit media. The content delivery network may include streaming applications for content delivery to the display screens 18. Content may include, for example, video, images, graphics, text, audio, or other data or combination thereof.

The content source 12 may include an application programming; interface (API) for communication with the location analytics device 10. In one embodiment, a venue manager may subscribe to analytics of certain areas in which display screens 18 are visible via the API. The API provides real time statistics of the number of users and the dwell time in the area. The content source 12 (e.g., content distribution network) uses this information to provide content and advertisements based on the dwell time of users in that area. Information as to the number of users in the vicinity of the display screen 18 when advertisements are displayed may also be used for billing purposes.

The display screens 18 are configured to display content received from the content source 12. The display screen 18 may comprise one or more digital sign (electronic display) operable to display content (e.g., advertisement, information, messages). The display screen 18 may comprise, for example, an LCD (liquid crystal display) screen, LED (light emitting diode) screen, plasma display, projected image screen (rear projection screen, front projection screen), or any other suitable device.

It is to be understood that the network shown in FIG. 1 and described herein is only an example and that the embodiments may be implemented in networks having different network topologies or network devices, without departing from the scope of the embodiments. For example, there may be more than one location analytics device 10 providing input to the content source 12, or more than one content source providing content to the display screens 18.

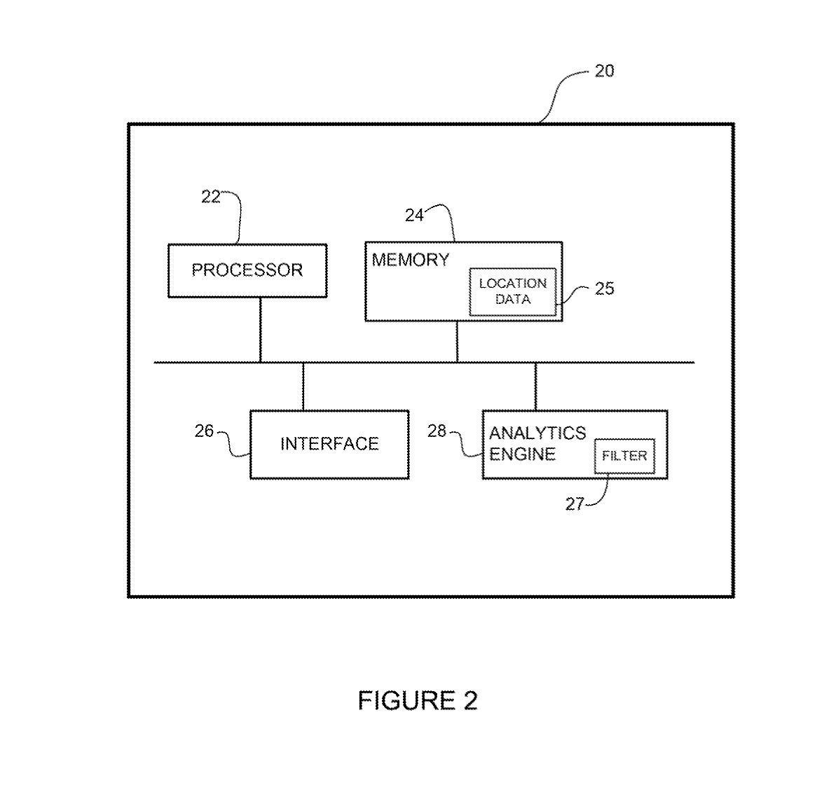

FIG. 2 illustrates ah example of a network device 20 (e.g., location analytics device, content source) that may be used to implement the embodiments, described herein. In one embodiment, the network device 20 is a programmable machine that may be implemented in hardware, software, or any combination thereof. The network device 20 includes one or more processor 22, memory 24, network interface 26, and analytics engine 28.

Memory 24 may be a volatile memory or non-volatile storage, which stores various applications, operating systems, modules, and data for execution and use by the processor 22. Memory stores location data 25 obtained by the location tracking system and information used by the analytics engine 28. The location data 25 may be stored, for example, in cache, a database, or any other suitable data structure.

Logic may be encoded in one or more tangible media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor, technology, or any other suitable medium.

The network interface 26 may comprise any number of interfaces (linecards, ports) for receiving data or transmitting data to other devices. The interface 26 may include, for example, an Ethernet interface for connection to a computer or network.

In one embodiment, the analytics engine 28 includes a filter 27 for filtering location data, as described in detail below. The analytics engine 28 derives location analytics from the filtered location data. The analytics engine 28 may comprise a module, computer code, or other device. For example, the analytics engine 28 and filter 27 may comprise computer code stored in memory 24.

It is to be understood that the network device 20 shown in FIG. 2 and described above is only an example and that different configurations of network devices may be used. For example, the network device 20 may further include any suitable combination of hardware, software, algorithms, processors, devices, components, or elements operable to facilitate the capabilities described herein.

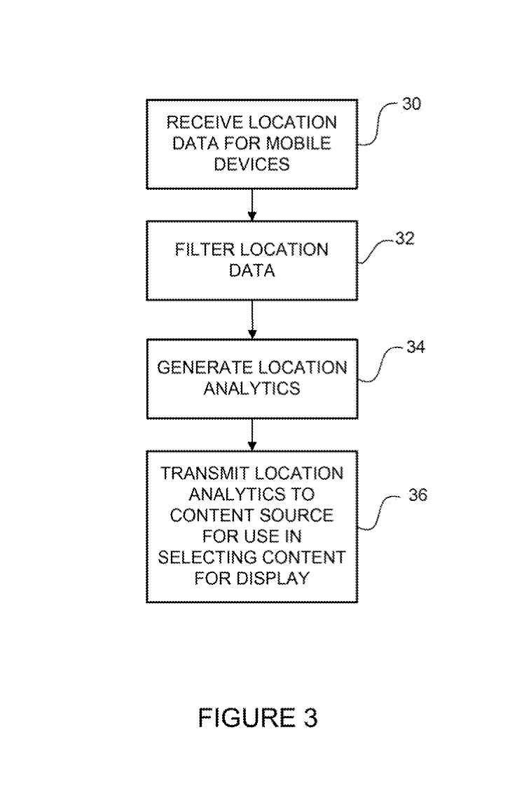

FIG. 3 is flowchart illustrating an overview of a process for generating mobile device location analytics for use in content selection; in accordance with one embodiment. At step 30, the location analytics device 10 receives location data for a plurality of mobile devices located in an area comprising display screen 18. This may include receiving calculated location data from a tracking device, or wireless signal data (raw location data) from one or more access points 15. As described in detail below, the location data may be filtered based on a confidence factor of the data (step 32). The location analytics device TO processes the filtered location data to generate location analytics comprising dwell time of the mobile device users (step 34). The location analytics data is transmitted to the content source 12 for use in selecting content for display on one or more display screens 18 (step 36).

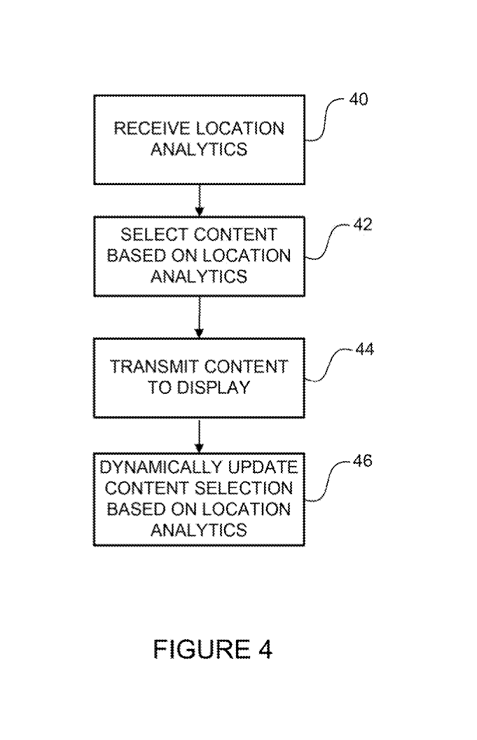

FIG. 4 is a flowchart illustrating an overview of a process for content delivery based on location analytics, in accordance with one embodiment. At step 40, the content source 12 receives location analytics from the location analytics device 10. As described above, the location analytics may be transmitted from a remote analytics device 10 or the location analytics device may be integrated with the content source and the analytics transmitted between components within the integrated device. The location analytics may be received for one or more areas as requested by the content source 12. The content source 12 selects content for display on the display screen 18 based on the received location analytics (step 42). For example, if the location analytics indicate that mobile device users are spending a lot of time in the vicinity of the display screen 18 (long dwell time), the content source 12 may select content with a long duration (i.e., long play time).

The content source 12 transmits the content to the display screen 18 (step 44). The content may be delivered, for example, as streaming media or as a content file with a schedule for displaying the content. The content selection may be automatically adjusted by the content source 12 based on changes in location analytics (step 46). For example, the location analytics may indicate that mobile device users are moving more quickly through an area in which the display screen 18 is located. In this case, the content source 12 may begin to transmit advertisements with shorter duration. The content source 12 may receive updates from the location analytics device 10 at periodic intervals. The intervals may vary based on the time of the day (e.g., receive updates more often at lunch time or evening) or day of the week (e.g., receive updates more often on weekends).

It is to be understood that the processes shown in FIGS. 3 and 4 and described above are only examples and that steps may be added, combined, or modified, without departing from the scope of the embodiments.

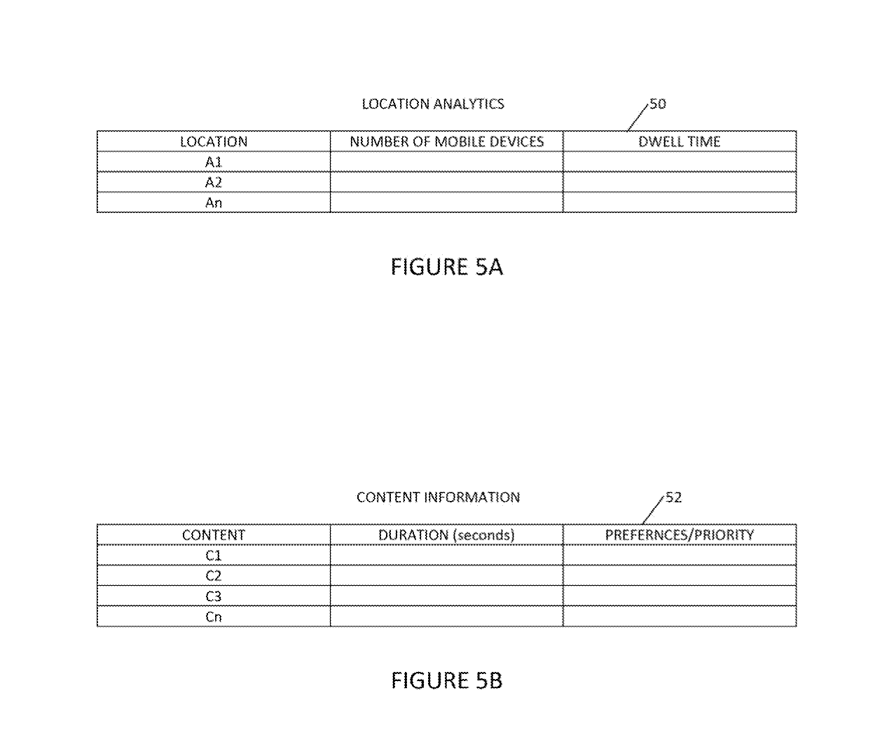

Examples of information provided in the location analytics and used with; the location analytics for content selection are shown in FIGS. 5A and 5B.

The table 50 shown in FIG. 5A includes a column for location (A1, A2, . . . An), number of mobile devices, and dwell time for the mobile devices. As previously described, the area may be defined by xy coordinates, distance from a fixed location (e.g., display screen), access point coverage area, or other identifier. The table 50 includes the number of mobile devices in each area and dwell time of the mobile device users for a specified interval of time. The dwell time may indicate, for example, an average dwell time for the mobile devices in the area. The location analytics may be generated from data collected over any interval of time (e.g., 15 minutes, 3 hours, 24 hours, or other interval) and periodically or continuously updated as new location analytics are calculated.

The table 52 shown in FIG. 5B provides information for different content (C1, C2, C3, . . . Cn). The table 52 includes a duration (e.g., time in seconds from start of advertisement until end of advertisement) for each content. Other data (e.g., preferences, priority) associated with the content may also be included in the table for use in selecting the content to transmit to the display screen 18. For example, if more than one content have the same duration, the content source 12 may select the content with a higher priority or one that has not been played recently. In another example, an advertiser may prefer that their advertisement be played in the evening. The table may also include demographic or store/location based information that can be used in selecting the best content for display. The content information is used along with the location analytics to select content to be displayed on the display screen 18.

It is to be understood that the data and data structures shown in FIGS. 5A and 5B are only examples and that other data may be collected or different data structures used, without departing from the scope of the embodiments. For example, as described below, user preferences may be identified for one or more of the mobile devices 14 and used in the content selection process.

In one embodiment, data from more than one area is used in selection of content to display. For example, if the mobility behavior of users in nearby areas is available, then the advertisements can be synced up across multiple displays 18. The location information may indicate, for example, that the users generally move from a first area to a second area. The display screens 18 in the first and second areas may then be configured to play the same content with the display screen in the second area having a small lag with respect to the content played in the first area, based on the mobility speed of the users. Other intelligent programming can be used based on the mobility pattern of the user. For example, if users generally move from a first area to a second area, then advertisements pertaining to shops in the second area may be displayed on the display screens 18 in the first area.

In one embodiment, mobile device users that have signed up for a loyalty or other consumer program, can be tracked and the advertisements selected based at least in part, on the shopping patterns or preferences of the users in that area.

The following describes examples of methods that may be used by a location tracking device (e.g., location analytics device 10 or other device in communication with the location analytics device) to track the mobile devices 14. It is to be understood that these are only examples and other methods may be used, as are well known by those skilled in the art.

The locations of the mobile devices 14 may be identified using, for example, WiFi technology. In one embodiment; the location tracking device is configured to track any IEEE 802.11 device using RF (radio frequency) signals. The RF signals may be processed, for example, to identify received signal strength (RSSI) or a time difference of arrival (TDOA). With RSSI, the access points 15 receive a signal from the mobile device 14 and measure a signal parameter such as signal strength indication of the received signal and forward the measurement to the location tracking device. The APs 15 may also send additional data such as antenna type, antenna gain, antenna orientation, etc. to the location tracking device. With TDOA, the APs 15 measure time, of arrival (ToA) and the location tracking device determines from time differences of arrival an initial estimate location.

In one embodiment, the location tracking device tracks the mobile devices 14 using x-position and y-position (xy coordinates). Any number of x-position and y-position measurements may be obtained. The location data may be sent to a server containing a location database, along with a timestamp corresponding to when the mobile device 14 was at the location so that the position measurements may be processed such that a speed of the mobile device user may be determined. After the position coordinates and corresponding time measurements are obtained, changes in position coordinates with respect to changes in time can be estimated and stored. The estimates of changes in position coordinates with respect to changes in time may be used to calculate speed of the mobile device 14.

As noted above, the location data may be filtered and the analytics derived from the filtered location data. The following describes examples of filtering that may be performed on WiFi based location data prior to considering the location data for analytics.

The raw location data may be passed through an initial filter (e.g., Kalman filter) to smooth the data out after the raw location is calculated. However, this initial filter may not compensate for all errors, since it may be based on the previous location measurements as it is done real time and by design it needs to apply conservative filtering as quick location updates are expected. These errors can be corrected in post processing after all location data is known, with the use of additional parameters and filtering, as described below.

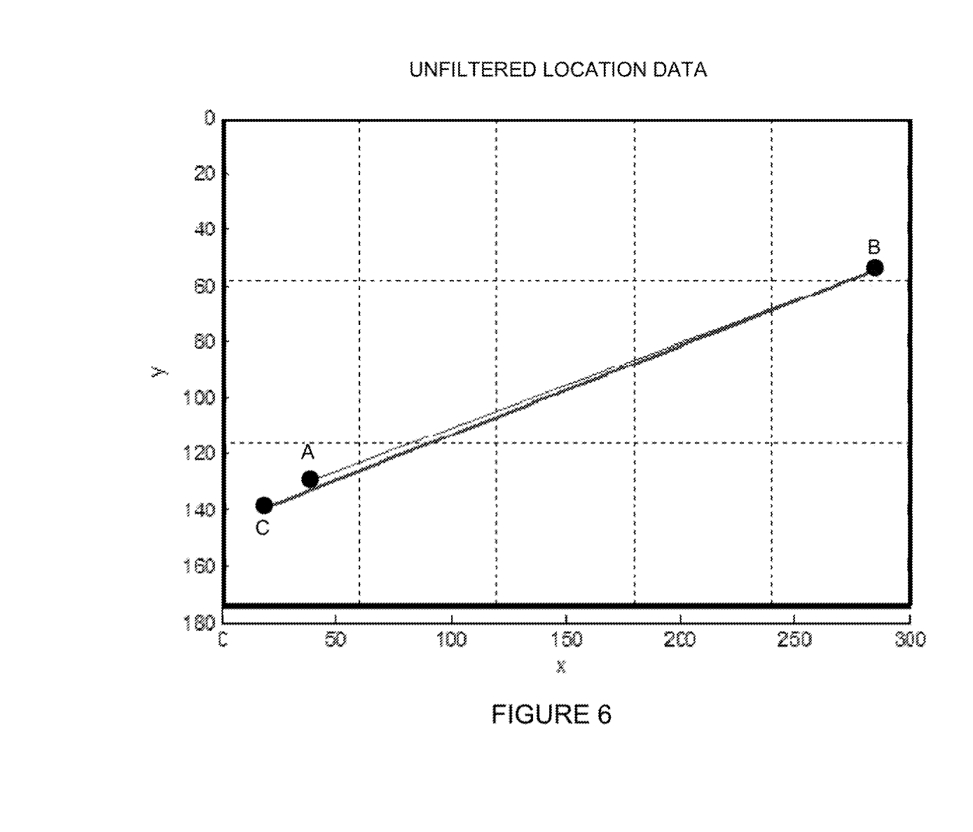

One of the most general cases of mobility is when the mobile device 14 moves and then remains stationary at a location before moving again, and then repeats this pattern, or performs any portion of this sequence (e.g., user remains stationary or is always moving). FIG. 6 illustrates movement of a client (mobile device 14) with a simplified mobility pattern. The client's position is indicated by xy coordinates. The locations and movements are plotted on a graph comprising a grid, pattern. In the example shown in FIG. 6, each square represents a 60 ft.×60 ft. area and the graph covers an area 300 ft. (x direction) by 180 ft. (y direction). Any size grid may be used to plot the location data and the size may be dynamically determined based on a density of the location (e.g., via clustering algorithms such as k-means clustering). The thickness of the line represents the time difference between the two points. In the example shown in FIG. 6, the user started at location A, moved to location B, and then to location C. The position and time data collected for the movement shown in FIG. 6 indicated that the user passed from A-B-C in 3.2 minutes. Although this is physically possible as the total distance is 538 feet (speed of 2.77 ft./sec), it is highly unlikely, based on the following two reasons.

First, the dwell times and movement of the user shown in FIG. 6 indicates anomalous behavior. The dwell time of the client in the vicinity of locations A and C before moving from location A is about 22 minutes, and the dwell time of the client in the vicinity of locations A and C after moving to location C is about 14 minutes, whereas the user moved from A-B-C in 3.2 minutes.

Second, a list of APs that heard the client at locations A, B, and C indicates poor location quality for location B:

i) in position A, there were 4 APs>−75 dBm hearing the client;

ii) in position B, there was 1 AP=−85 dBm hearing the client; and

iii) in position C, there were 9 APs>−75 dBm hearing the client.

In the above example, the average dwell time for the client in the vicinity of locations A and C is actually 22+3.2+14=39.2 minutes. However, due to the WiFi location anomaly the average dwell time would be calculated as mean (22, 14)=18 minutes. This results in a large error (about 50% error). Moreover, the mobility pattern of the client would be incorrectly determined.

Another problem with the unfiltered location data is that error in location accuracy is not considered. WiFi based location includes some error in location (e.g., five meters on average), which needs to be compensated for during dwell time calculations.

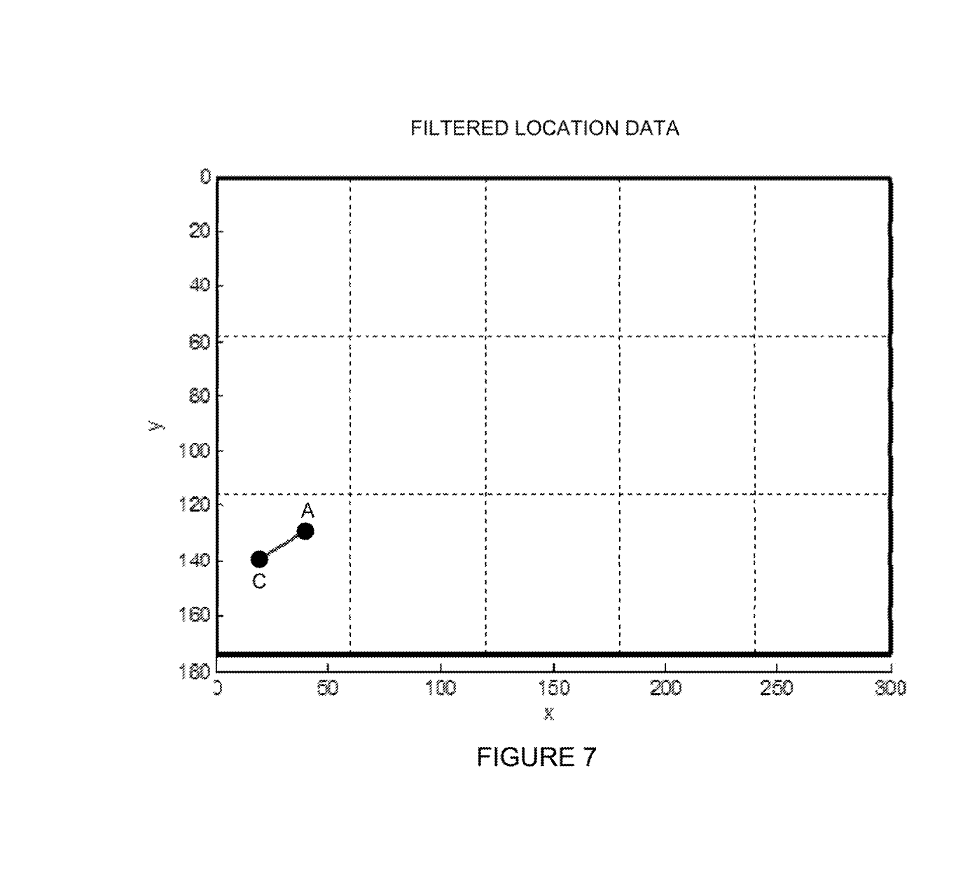

In one embodiment, the location data is filtered by taking into account a location confidence factor. In the example shown in FIG. 6, location B had a very low confidence factor as compared to the adjacent readings (locations A and C). If the location data is filtered, the outlier point (location B) is pulled into locations A and C, as shown in FIG. 7. The filtering increases the dwell time in the area containing locations A and C from 18 minutes to 39.2 minutes and smoothens the mobility pattern.

The removal of low confidence readings by filtering the location data makes the mobility pattern much clearer. It also provides a better estimate of the dwell time and the mobility pattern of the client, without eliminating legitimate short movements of the client.

In one embodiment, filtering is performed using a smoothening algorithm to remove outlier data (e.g., location data point B in FIG. 6). The following is an example of a smoothening algorithm used to apply a confidence factor (cf). The xy values are passed through a three point weighted moving average filter as follows:
(i) for the first data point, filtered xy is set equal to xy;
(ii) for i1=second data point to (last data point−1), use Equation (1) below; and
(iii) for i1=last data point use Equation (1) below but with limits t=i1−1 to t−i1.

$$Filtered xy = \frac{{Σ}_{t = i 1 - 1}^{t = i 1 + 1} xy ( t ) * {e}^{cf ( t )}}{{Σ}_{t = i 1 - 1}^{t = i 1 + 1} {e}^{cf ( t )}} \qquad ( 1 )$$

In the above example, exponential function (e^{cf(t)}) is one example of a weighting factor. Other functions may be used to take into account the confidence factor.

The confidence factor (cf) may be based oh various parameters. Examples of parameters and confidence factor weights are shown below in Table I. It is to be understood that the parameters and weights shown in Table I are only examples and that other parameters may be used. For example, a metric that represents one-half of a side of a square encompassing the 90% probability region of location estimation may be used in as a confidence factor. Also, any combination of these or other parameters may be used to calculate the confidence factor.

TABLE 1

| Parameter | Effect |
|---|---|
| Number of APs heard within | If less than 3 then very low confidence |
| past 100 seconds for the | (weight~0.1-0.3; |
| location calculation reading | if between 3-7 then medium confidence |
| | (weight~0.3-0.9); |
| | if more than 7 then high confidence |
| | (weight~1). |
| Time difference between the | If time difference between the readings |
| location calculation reading | is low, then higher correlation (higher |
| and adjacent readings | relative weight) and otherwise low |
| | (lower relative weight). |
| Distance difference between | If the distance within x meters (e.g., five |
| the location calculation reading | meters or other average error of the system), |
| and adjacent readings | then higher relative weight, otherwise lower |
| | relative weight—as this may be just jitter). |

Other filtering operations may be used in combination with the smoothening algorithm described above. For example, a larger size weighted moving average filter, particle filter, Kalman filter, or other filter may be used instead of a simple weighted moving average filter. Kalman filter parameters may be modified over time for a user based on the user's mobility characteristics (see, for example, U.S. Patent Application Publication No. 2010/0271228).

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving location data for a plurality of mobile devices located in an area comprising a display screen;
processing at a network device, said location data to generate location analytics for said area, said location analytics comprising dwell time for users of the mobile devices; and
transmitting said location analytics to a content source operable to select content for display on the display screen based on said location analytics.

2. The method of claim 1 wherein processing comprises filtering said location data.

3. The method of claim 2 wherein filtering said data comprises applying a confidence factor to said location data.

4. The method of claim 3 wherein said confidence factor is based on a number of access points receiving a signal from the mobile device.

5. The method of claim 3 wherein said confidence factor is based on a time difference between data points within said location data.

6. The method of claim 3 wherein said confidence factor is based on a distance difference between data points within said location data.

7. The method of claim 3 wherein filtering said location data comprises calculating filtered location data for a second data point to a (last−1) data point as:
$$\frac{{Σ}_{t = i 1 - 1}^{t = i 1 + 1} xy ( t ) * {e}^{cf ( t )}}{{Σ}_{t = i 1 - 1}^{t = i 1 + 1} {e}^{cf ( t )}}$$
wherein:
xy is a location coordinate of one of the mobile devices;
cf is said confidence factor;
t is a time; and
i1 is a data point.

8. The method of claim 1 further comprising automatically selecting content to display on the display screen based on duration of said content.

9. The method of claim 1 wherein said content is selected based on said location analytics for at least two different areas.

10. An apparatus comprising:
a processor for receiving location data for a plurality of mobile devices located in ah area comprising a display screen, processing said location data to generate location analytics for said area, said location analytics comprising dwell time for users of the mobile devices, and transmitting said location analytics to a content source operable to select content for display on the display screen based on said location analytics; and
memory for storing said location analytics.

11. The apparatus of claim 10 wherein said content is selected based on said location analytics for at least two different areas.

12. The apparatus of claim 10 further comprising a filter for filtering said location data based on a confidence factor.

13. The apparatus of claim 12 wherein said confidence factor is based on a number of access points receiving a signal from the mobile device.

14. The apparatus of claim 12 wherein said confidence factor is based on a time difference between data points within said location data.

15. The apparatus of claim 12 wherein said confidence factor is based on a distance difference between data points within said location data.

16. The apparatus of claim 10 wherein the processor is configured to automatically select content to display on the display screen based on duration of said content.

17. The apparatus of claim 10 wherein said content comprises advertisements, at least two of said advertisements having a different duration.

18. Logic encoded on one or more tangible computer readable media for execution and when executed operable to:
generate location analytics from location data for a plurality of mobile devices located in an area comprising a display screen, said location analytics comprising dwell time for users of the mobile devices; and
transmit said location analytics to a content source operable to select content for display on the display screen based on said location analytics.

19. The logic of claim 18 wherein said logic is further operable to filter said location data based on a confidence factor to generate said location analytics.

20. The logic of claim 18 wherein said content is selected based on said location analytics for at least two different areas.
